(19) United States
(12) Patent Application Publication
(10) Pub. No.: US 2008/0146133 A1
(43) Pub. Date: Jun. 19, 2008

(54) EXHAUST HOOD WITH A COLLECTING CHANNEL

(75) Inventors: Ole Behrens, Arnsberg (DE); Peter Wienand, Arnsberg (DE)

Correspondence Address: DARBY & DARBY P.C., P.O. BOX 770, Church Street Station, New York, NY, 10008-0770, US

(73) Assignee: Miele & Cie. KG, Guetersloh (DE)

(21) Appl. No.: 11/954,619

(22) Filed: Dec. 12, 2007

(30) Foreign Application Priority Data
Dec. 19, 2006 (DE) 10 2006 060 497.0

(51) Int. Cl. B08B 15/00

(52) U.S. Cl. 454/49

(57) ABSTRACT

An exhaust hood is provided that includes a housing, a filter, and a collecting channel. The collecting channel is disposed on the housing, below the filter, and configured to collect liquid that emerges from the filter. The collecting channel includes a bent part with side walls formed from a single piece of sheet metal.

### CROSS REFERENCE TO RELATED APPLICATIONS

This application claims benefit German Patent Application No. 10 2006 060 497.0, filed Dec. 19, 2006, which is hereby incorporated by reference herein.

### FIELD

The present invention relates to an exhaust hood having a housing, a filter, and a collecting channel mounted to the housing below the filter.

### BACKGROUND

German Patent Publication DE 34 16 692 A1 describes exhaust hoods having a housing, a filter, and a collecting channel mounted to the housing below the filter and designed to collect liquid which emerges from the filter, the collecting channel being a sheet-metal part.

### SUMMARY

It is an aspect of the present invention to provide an exhaust hood that is simple to construct.

In an embodiment, the present invention provides an exhaust hood that includes a housing, a filter and a collecting channel. The collecting channel includes a bent part having side walls formed from a single piece of sheet-metal. The collecting channel is disposed on the housing below the filter and configured to collect liquid emerging from the filter.

### BRIEF DESCRIPTION OF THE DRAWINGS

Aspects of the present invention will now be described by way of exemplary embodiments with reference to the following drawings, in which:

FIG. 1 is a partial sectional front view of an exhaust hood according to an exemplary embodiment of the present invention;

FIG. 2 is a partial enlarged perspective view of the collecting channel shown in FIG.

FIG. 3 is a partial view showing the collecting channel of FIG. 2 as a blank to be bent;

FIG. 4 is a partial perspective detail view showing the collecting channel of FIG. 1 in the area of the end that is located at the rear in the plane of FIG. 1; and

FIG. 5 shows the collecting channel of FIG. 4 in a partial view rotated 90° with respect to the normal to the plane of the sheet.

### DETAILED DESCRIPTION

An advantage offered by the present invention is the simple construction of an exhaust hood. Since the collecting channel is a bent part whose side walls are all formed from a single piece of sheet metal, the collecting channel, and thus the exhaust hood, is particularly easy to construct.

In an exemplary embodiment, the collecting channel is a separate part which is mountable to the housing. Thus, the collecting channel can be manufactured or purchased as a separate part.

In another exemplary embodiment, the collecting channel is adapted to hold the filter. This further simplifies the construction of the exhaust hood of the present invention, because the collecting channel also serves as a holder for the filter.

The collecting channel may be selected within wide suitable limits in terms of type, arrangement, dimensions and shape. Conveniently, at least two side walls of the collecting channel are separated by a gap, and one of the two side walls is folded over so that this side wall is double-layered, one of the two layers covering the gap.

In an embodiment, the layer covering the gap abuts the gap so closely that the gap is substantially sealed against passage of liquids. Thus, the gap does not necessarily have to be sealed, for example, by sealants or coatings.

In a further exemplary embodiment, the collecting channel has a mounting tab for interlocking engagement with the housing. Thus, the collecting channel can be mounted to the housing in a particularly simple manner.

In an embodiment, the mounting tab has a land and a grip at the free end of said land; the grip being completely insertable through an opening in the housing and twistable about the longitudinal axis of the mounting tab to provide the interlocking engagement as the collecting channel is brought into a mounted position. Thus, the attachment of the collecting channel to the housing is further simplified, because there is no need for additional fastening means, such as screws or the like.

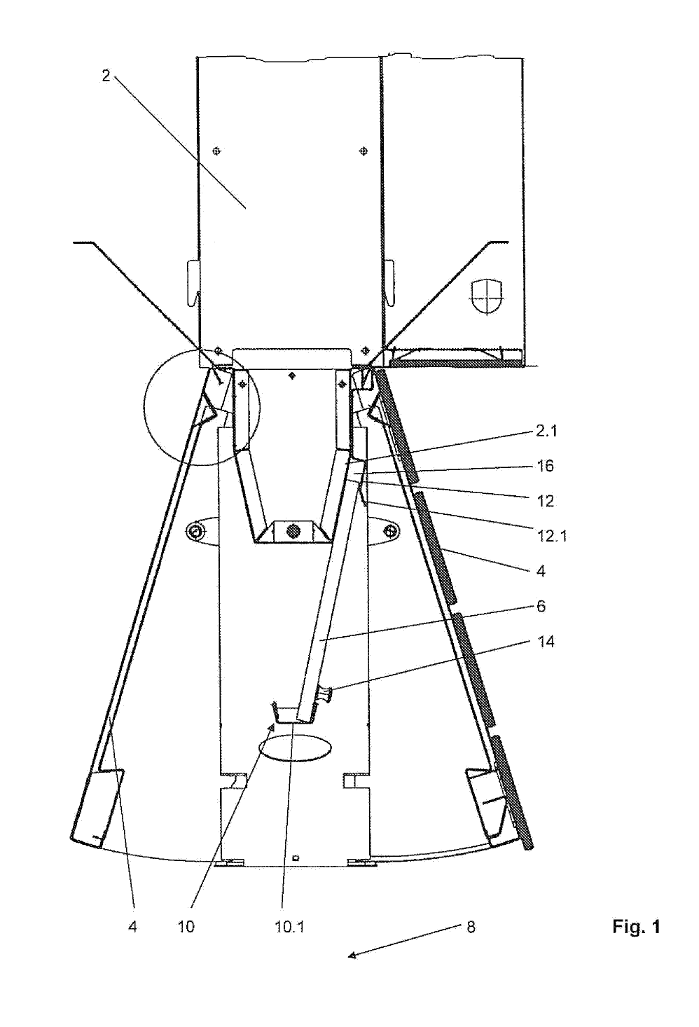

In FIG. 1, an exhaust hood according to an exemplary embodiment of the present invention is shown in a partial view. The exhaust hood has a housing 2 which is in the form of a chimney housing and to which are secured two vapor-collecting canopies 4 and two filters 6, of which only the right filter 6 is shown in FIG. 1. The exhaust air rising from a work area 8 located below the exhaust hood, for example a cooktop, is extracted through filters 6 by a fan. A collecting channel 10 for collecting liquid which emerges from filters 6 is located below filters 6 and is interlockingly connected to housing 2, as will be explained in greater detail below. However, it is, in principle, also possible to use other suitable fastening techniques. In order for filters 6 to be detachably secured to housing 2, they are supported on collecting channel 10. As seen in the plane of FIG. 1, filters 6 are held at the upper portion by a bracket 12 provided on housing 2. In the mounted state, filters 6 are clamped between bracket 12 and an opposite housing part 2.1, as illustrated. For this reason, bracket 12 is flexible in construction and has an angled portion 12.1 to facilitate the handling of filters 6. In order to move filters 6 from a removed position to the retained position shown in FIG. 1, filters 6 are inserted with the upper portion in between housing part 2.1 and bracket 12 from below using handles 14, and then lifted, with the lower portion, over collecting channel 10. To this end, the holding receptacle 16 formed by housing part 2.1 and bracket 12 is designed such that it is of sufficient depth. Finally, filters 6 are placed, with the lower portion, on the side wall 10.1 of collecting channel 10, which forms the bottom thereof. Filters 6 are thus secured to housing 2 of the exhaust hood.

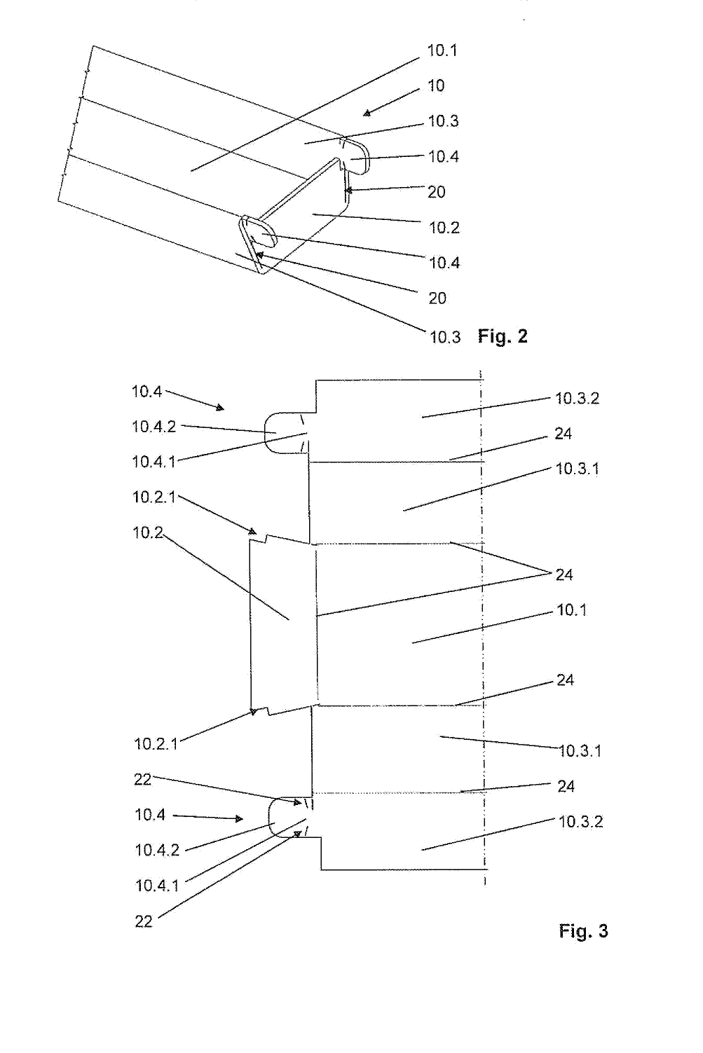

Collecting channel 10 is shown in more detail in FIG. 2. Collecting channel 10 is made from sheet metal. All side walls of collecting channel 10 are bent from a single piece of sheet metal, which is shown particularly well in FIG. 3. In addition to bottom 10.1, collecting channel 10 has two opposing end side walls 10.2 and two opposing longitudinal side walls 10.3. FIG. 2 shows only one end side wall 10.2. However, the explanations given herein apply also to the end side wall that is not shown. Longitudinal side walls 10.3 are double-layered, including an outer layer 10.3.1 and an inner layer 10.3.2, respectively, so that gaps 20 between longitudinal side walls 10.3 and end side walls 10.2 are covered by the inner layers 10.3.2 of longitudinal side walls 10.3. The respective inner layers 10.3.2 of longitudinal side walls 10.3 abut the gaps 20 so closely that gaps 20 are substantially sealed against passage of liquids, such as a water/grease mixture, or the like.

Moreover, the inner layer 10.3.2 of each longitudinal side wall 10.3 is formed with a mounting tab 10.4 at each of the ends of collecting channel 10. Mounting tabs 10.4 each have a land 10.4.1 and a grip 10.4.2; land 10.4.1 and grip 10.4.2 of each mounting tab 10.4 being separated by a slit 22 on each side. In order to make mounting tabs 10.4 more rugged and easier to handle, mounting tabs 10.4 are of increased width. To allow the blank shown in FIG. 3 to be bent to form the collecting channel in accordance with FIG. 2, the two end side walls 10.2 are each provided with two notches 10.2.1

FIG. 3 also shows the bending lines 24 about which the blank is bent.

Referring to FIGS. 2 through 5, it will now be described in more detail how the collecting channel 10 bent from the blank is mounted to housing 2.

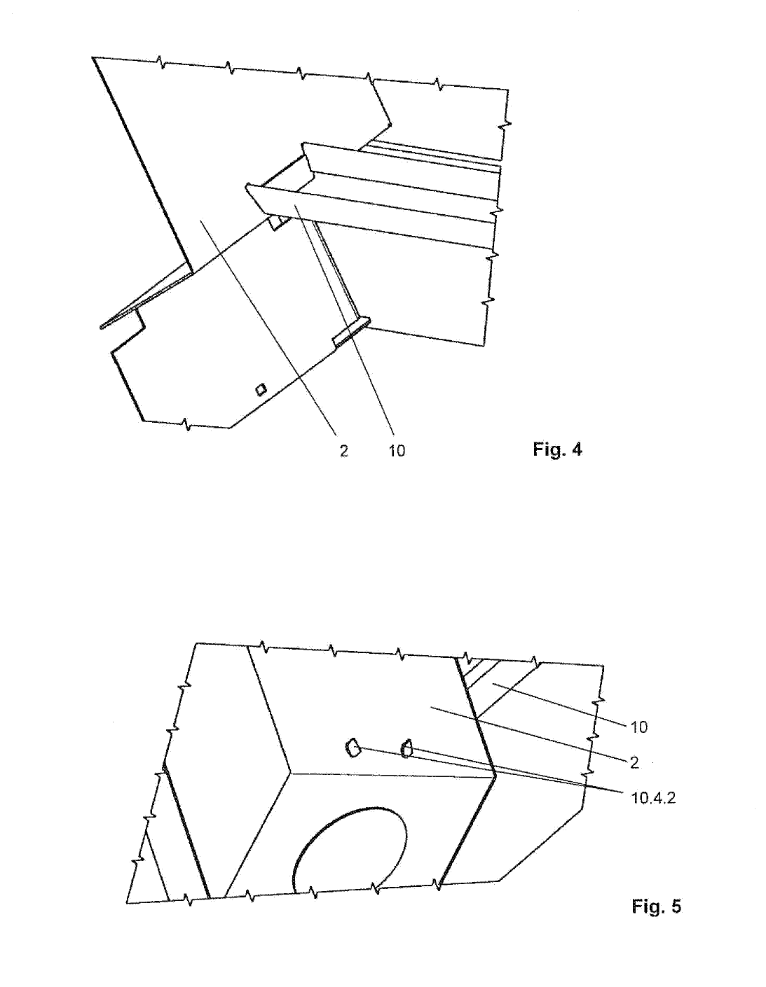

Once collecting channel 10 has been given its final shape (see FIG. 2), collecting channel 10 is inserted with mounting tabs 10.4 into openings formed in housing 2 and corresponding to mounting tabs 10.4, said housing also being made from sheet metal. In the process, the grip 10.4.2 of each mounting tab 10.4 is fully inserted through the opening associated therewith. Land 10.4.1 of mounting tab 10.4 is of suitable length to bridge the thickness of the sheet metal forming housing 2. In order to achieve the interlocking engagement between collecting channel 10 and housing 2, the installer then twists grips 10.4.2 of mounting tabs 10.4 about the longitudinal axes of mounting tabs 10.4, for example, using a pair of pliers, so that grips 10.4.2 of mounting tabs 10.4 will engage behind the edges of the openings in housing 2. In this regard, see also FIGS. 4 and 5.

The present invention is not limited to the exemplary embodiments described herein. For example, filters 6 or collecting channel 10 could be secured to housing 2 using other suitable fastening techniques. Moreover, housing 2 could be made from another suitable material. Additionally or alternatively to the substantially leakproof configuration of gaps 20 obtained by the bending of the blank, it is also possible to seal gaps 20 using a suitable sealant and/or by a coating, such as varnish.

The present invention is not limited to the exemplary embodiment described herein.

What is claimed is:

1. An exhaust hood, comprising:
a housing;
a filter; and
a collecting channel including a bent part having side walls formed from a single piece of sheet-metal, the collecting channel being disposed on the housing below the filter and configured to collect liquid emerging from the filter.

2. The exhaust hood recited in claim 1, wherein the collecting channel is a separate part mountable to the housing.

3. The exhaust hood recited in claim 1, wherein the collecting channel is configured to hold the filter.

4. The exhaust hood recited in claim 2, wherein the collecting channel is configured to hold the filter.

5. The exhaust hood recited in claim 1, wherein at least two side walls of the collecting channel are separated by a gap, one of the two side walls folded to form a double-layer, one of the two layers covering the gap.

6. The exhaust hood recited in claim 2, wherein at least two side walls of the collecting channel are separated by a gap, one of the two side walls folded to form a double-layer, one of the two layers covering the gap.

7. The exhaust hood recited in claim 3, wherein at least two side walls of the collecting channel are separated by a gap, one of the two side walls folded to form a double-layer, one of the two layers covering the gap.

8. The exhaust hood as recited in claim 5, wherein the layer covering the gap abuts the gap so as to substantially seal the gap against passage of liquids.

9. The exhaust hood as recited in claim 1, wherein the collecting channel includes a mounting tab arranged to form an interlocking engagement with the housing.

10. The exhaust hood as recited in claim 2, wherein the collecting channel includes a mounting tab arranged to form an interlocking engagement with the housing.

11. The exhaust hood as recited in claim 3, wherein the collecting channel includes a mounting tab arranged to form an interlocking engagement with the housing.

12. The exhaust hood as recited in claim 5, wherein the collecting channel includes a mounting tab arranged to form an interlocking engagement with the housing.

13. The exhaust hood as recited in claim 8, wherein the collecting channel includes a mounting tab arranged to form an interlocking engagement with the housing.

14. The exhaust hood as recited in claim 9, wherein the mounting tab includes a land and a grip positioned at a free end of the land; the grip completely insertable through an opening in the housing and twistable about the longitudinal axis of the mounting tab so as to provide the interlocking engagement when the collecting channel is brought into a mounted position.
